(19) United States
(12) Patent Application Publication
(10) Pub. No.: US 2024/0242898 A1
(43) Pub. Date: Jul. 18, 2024

(54) COAXIAL ENERGY HARVESTING AND STORAGE

(71) Applicant: UNIVERSIDADE DO PORTO, PORTO (PT)

(72) Inventors: Maria Helena SOUSA SOARES DE OLIVEIRA BRAGA, PORTO (PT); Pedro Manuel PONCES RODRIGUES DE CASTRO CAMANHO, PORTO (PT); Federico DANZI, PORTO (PT)

(21) Appl. No.: 18/561,956

(22) PCT Filed: May 20, 2022
(86) PCT No.: PCT/IB2022/054744

§ 371 Date: Nov. 17, 2023

(30) Foreign Application Priority Data
May 20, 2021 (PT) 117244

(51) Int. Cl. H01G 11/56; H01G 11/06

(52) U.S. Cl. CPC H01G 11/56; H01G 11/06

(57) ABSTRACT

The present invention is an energy storage and/or harvesting device that may also perform as a structural component, a coaxial cable or another element of an electrical circuit. The device is an energy storage and/or harvesting device constituted by a cylindrical like internal element, which constitutes one electrode and current collector, surrounded by a dielectric material that is also an electrolyte and may, or may not, be a ferroelectric material. The external shell holds, or is the second electrode, and current collector. The outer cylinder is electrically insulated and may be reinforced by materials that enhance the device's structural properties.

### TECHNICAL FIELD

The present invention is an energy storage and/or harvesting device that may also perform as a structural component, a coaxial cable or another element of an electrical circuit.

### BACKGROUND ART

A coaxial cylindrical capacitor shows a capacitance, C, that is given by,

$$C = \frac{2 π {ε}_{0} {ε}_{r} ℓ}{ln ( b / a )}$$

where ε₀ is the permittivity of the vacuum, εᵣ is the relative permittivity of the dielectric material and ε=ε₀εᵣ its permittivity; the dielectric is also an electrolyte and may or not be a ferroelectric, [symbol] is the length of the cylinder, b is the external radius and α the inner radius of the dielectric material.

A device such as a battery or a capacitor as well as all the devices that can be emulated with a capacitor like behaviour at the interfaces and/or bulk constituted by elements that play the role of electrodes separated by a dielectric where the latter includes just a thin layer of vacuum with angstrom dimensions and show a voltage, ϵ, that is given by the following equation if the internal resistance is not accounted for,

$$ϵ = \frac{{μ}_{A} - {μ}_{C}}{e}$$

where μ_{A} is the chemical potential of the anode—negative electrode with higher chemical potential than the chemical potential of the cathode—positive electrode μ_{C} and e is the charge of one electron. The absolute chemical potentials reference is the vacuum μ_{vacuum}=0 (Physical scale).

The energy, E, stored in the device of [0002] is,

$$E = \int ϵ dq$$

where q is the stored capacity. The energy that can be effectively recovered E_{eff} is,

$${E}_{eff} = \int ( ϵ - {R}_{i} I ) dq$$

where Rᵢ is the internal resistance reflecting the ionic resistance to the diffusion of the ions and dipoles in the electrolyte, the interfacial resistance as well as the resistance to the conduction of the electrons in the electrodes, and

$$I = \frac{dq}{dt}$$

the current in the external circuit.

In an electrochemical device the mobile cations and the electrons reaching the positive electrode through the electrolyte and external circuit, respectively, react with the cathode active material usually giving rise to a two-phase equilibria that will gradually transform into a single phase that is richer in the mobile cation element than the initial phase. This reaction results in the increase of the electrochemical potential of the cathode during the discharge.

A superconductor enables the transmission of electrical power without any loss and exhibits no heat dissipation (no Joule effect).

A topologic or surface superconductor enables the transmission of electrical power without any loss through the surface, as previously described, while keeping its insulating behaviour in the bulk which still allows for the formation of double layer capacitors at the interface with the electrodes where the energy is stored.

A Ferroelectric material is a material that polarizes spontaneously and whose polarization can be reversed by the application of an external electric field. All Ferroelectrics are Pyroelectrics, their natural electrical polarization is reversible.

Ferroelectrics with extremely high dielectric constant like Li_{3-2y}M_{y}ClO (M═Be, Ca, Mg, Sr, and Ba), Li_{3-3y}A_{y}ClO (M═B, Al), Na_{3-2y}M_{y}ClO (M═Be, Ca, Mg, Sr, and Ba), Na_{3-3y}A_{y}ClO (M═B, Al), K_{3-2y}M_{y}ClO (M═Be, Ca, Mg, Sr, and Ba), K_{3-3y}A_{y}ClO (M═B, Al) or antiperovskites (crystalline materials) like Li_{3-2y-z}M_{y}H_{z}ClO (M═Be, Ca, Mg, Sr, and Ba), Li_{3-3y-z}A_{y}H_{z}ClO (M═B, Al), Na_{3-2y-z}M_{y}H_{z}ClO (M═Be, Ca, Mg, Sr, and Ba), Na_{3-3y-z}A_{y}H_{z}ClO (M═B, Al), K_{3-2y-z}M_{y}H_{z}ClO (M═Be, Ca, Mg, Sr, and Ba), K_{3-3y-z}A_{y}H_{z}ClO (M═B, Al), a mixture of thereof or a mixture of thereof with Li₂S, Na₂S, K₂S, Li₂O, Na₂O, K₂O, SiO₂, Al₂O₃, ZnO, AlN, LiTaO₃, BaTiO₃, HfO₂, or H₂S or a mixture of thereof with a polymer forming a composite such as PVDF or PVAc, can become a surface (1D, 2D or 3D) superconductor. This condition does not require being a bulk superconductor.

A classic Thermoelectric cell or Generator is constituted by a heat source and a heat sink separated by the thermoelectric material and a collector. Usually, the cell is constituted by two different TEs (an n-semiconductor and a p-semiconductor) to allow electrons (in n-semiconductor) to be conducted from the hot source to the hot sink and holes (in p-semiconductor) from the hot sink to the hot source. The working principle of TEGs depends on a temperature difference and a gradient,

$$J = - σ S ∇ T$$

where J is the current density, σ the electrical conductivity, S=ΔV/ΔT the Seebeck coefficient, ΔV the potential difference across the material when a temperature difference ΔT is applied, and V̅T the temperature gradient. Thermoelectric materials have demonstrated their ability to directly convert thermal into electrical energy via the Seebeck effect.

The Thermoelectric performance—for either power generation or as a heat pump in which electricity can drive a Peltier cooler-depends on the efficiency of the Thermoelectric material for transforming heat into electricity. The efficiency of a Thermoelectric material depends primarily on the Thermoelectric materials figure-of-merit, known as zT, zT=S²σT/κ, where κ is the thermal conductivity. It is not straightforward to find an n- and p-semiconductor pair that can be used near room temperature. The latter difficulty is identified as one of the problems in classic TEs and the others are related to obtaining a high electrical conductivity (σ), or low resistivity (ρ), while obtaining a high thermal conductivity (κ). Finally, the requirements partially translate into finding a semiconductor TE with a charge carrier concentration that is about 10²⁰ cm⁻³. This ‘ideal’ concentration of charge carriers is found associated with TE topological phenomena and, independently, with 2D and 3D topological superconductivity in polar metals such as certain ferroelectrics.

In the 1950s, the milestone concepts of narrow bandgap semiconductors and solid solutions led to the discovery of (Bi,Sb)₂(Te,Se)₃ and Bi₁₋ₓSbₓ TE systems, which have become the most successful TE materials for power generation and refrigeration near and below room temperature. The latest major advance started in the 1990s, and its development continues to date based on the novel ideas of low-dimensionality, ‘phonon-glass electron-crystal’ paradigm electronic structure engineering (band structure), hierarchical phonon scattering, and point defect engineering.

Pyroelectricity is a phenomenon in which temperature fluctuations applied to a pyroelectric material induce a change in polarization, which further causes the separation of charges. The term “temperature fluctuation” refers to the dynamic condition where temperature varies with time (e.g. oscillations). As such, pyroelectricity can result in an alternating current (AC). The pyroelectric phenomena depend, therefore, on a dynamic variation of the temperature expressed by I=A(dPₛ/dT)(dT/dt), where I is the harvested current, A is the surface area, P, is the spontaneous polarization, and T is the temperature.

Surface superconductivity is established in polar materials such as ferroelectric semiconductors. It is observed, in particular, in polar metal/insulator heterojunctions typically at low-temperatures (<50 K) where the polar material is a superconductor with dielectric constant εᵣ>10³, converting the latter into ferroelectric “metals” with topological superconductivity.

Negative capacitance is related with topological phenomena and associated with processes conducing to local superconductivity which subsequently, fed by excitations, may result in electron tunnelling.

Negative resistance is related with catastrophic phenomena in ferroelectric-feedback cells and is associated with processes conducing to self-charge and self-cycling (oscillations).

Negative capacitance and resistance are phenomena constituting part of the feedback process in a cell containing a ferroelectric electrolyte with topological superconductivity. A coaxial cell may allow a similar ferroelectric-feedback phenomenon as the one found in coin, pouch, prismatic, and cylindrical (jellyroll) cells. This latter phenomenon allows for harvesting thermal energy as it relies on the alignment of the dipoles in the ferroelectric. The development of novel architectures for harvesting and subsequently storing energy brings important benefits to humankind.

A coaxial cable is used as a transmission line. It is constituted by a copper core, an inner dielectric insulator and a shield—Faraday cage that is usually a copper mesh. The theory behind the coaxial cable as a transmission line was described by the physicist, Oliver Heaviside who patented the design in 1880. The impedance Z of the coaxial cable depends both on the capacitance C and inductance L at high frequencies,

$$Z = \sqrt{\frac{L}{C}} = \frac{1}{2 π} \sqrt{\frac{μ}{ε}} ln ( \frac{b}{a} )$$

where L is the inductance and C is the capacitance of the cable, μ is the permeability and ε the permittivity of the dielectric, b is the external radius and α the inner radius of the dielectric.

A beam is a structural element whose axial dimension is orders of magnitude longer than the in-plane (cross-section) dimensions. Beams support bending and torsional moments, as well as normal and transverse (shear) forces.

The bending stiffness, K_{b}, of a beam composed of N materials is:

$${K}_{b} = {\sum }_{i = 1}^{N} {E}_{i}^{Y} {I}_{i}$$

where Eᵢ^{γ} is the Young's modulus of material i and Iᵢ is the second moment of area (area moment of inertia) of material i.

The normal stress acting on material i, σⁱ, along the longitudinal direction of a beam composed of N materials under the action of the bending moment M is:

$${σ}^{i} = - \frac{M {E}_{i}^{Y} y}{{\sum }_{i = 1}^{N} {E}_{i}^{Y} {I}_{i}}$$

where γ is the coordinate along the γ-axis of a Cartesian coordinate system with origin in the neutral axis of the beam composed of N materials.

The torsional stiffness, Kₜ, of a circular beam composed of concentric cylinders of N materials is,

$${K}_{t} = {\sum }_{i = 1}^{N} {G}_{i} {I}_{P i}$$

where Gᵢ is the shear modulus of material i and Iₚᵢ is the polar moment of area of material i.

The shear stress acting on material i, τⁱ, of a circular beam composed of concentric cylinders of N materials subjected to torsional moment M_{Ti} is:

$${τ}^{i} = \frac{{M}_{T i} r}{{I}_{P i}}$$

where r is the radial coordinate of a cylindrical coordinate system with origin in center of the circular beam composed of N materials. M_{Ti} is the torsional moment absorbed by material i,

$${M}_{T i} = \frac{{M}_{T} {G}_{i} {I}_{P i}}{{\sum }_{i = 1}^{N} {G}_{i} {I}_{P i}}$$

Synergetic effects between the energy harvesting and/or storage and structural performance can be obtained using an outer shell manufactured using polymer-based composite materials (laminated or otherwise) with geometries typically used in beams (circular, square, rectangular, U or C-shape, L-Shape, W-shape, T-shape, Z-shape, and I-shape).

### SUMMARY

The present invention describes a Coaxial cell comprising a solid electrolyte dielectric arranged between two similar or dissimilar nearly coaxial or coaxial materials comprising an inner conductor and an outer conductor.

In a proposed embodiment of present invention, the solid dielectric electrolyte comprises a range of the materials composed by R_{3-2y}M_{y}Cl₁₋ₓHalₓO_{1-z}A_{z} with (R═Li, Na, K; M═Be, Ca, Mg, Sr, and Ba; Hal═F, Br, I; A═S, Se) and 0≤y≤0.5, 0≤x≤1, and 0≤z≤1, R_{3-3y}M_{y}Cl₁₋ₓHalₓO_{1-z}A_{z} with (R═Li, Na, K; M═B, Al; Hal═F, Br, I; A═S, Se) and 0≤y≤0.5, 0≤x≤1, and 0≤z≤1, R_{3-2y-z}M′_{y}H_{z}Cl₁₋ₓHalₓO_{1-d}A_{d} (R═Li, Na, K; M′ ═Be, Ca, Mg, Sr, and Ba; Hal═F, Br, I; A═S, Se) and 0≤y≤0.5, 0≤z≤2, 0≤x≤1, and 0≤d≤1, R_{3-3y-z}M′_{y}H_{z}Cl₁₋ₓHalₓO_{1-d}A_{d} with 0≤y≤0.5, 0≤z≤2, 0≤x≤1, and 0≤d≤1, a mixture of thereof or a mixture of thereof with Li₂S, Na₂S, K₂S, Li₂O, Na₂O, K₂O, SiO₂, Al₂O₃, ZnO, AlN, LiTaO₃, BaTiO₃, HfO₂, or H₂S or a mixture thereof with a polymer, a plasticizer, or a glue.

Yet in another proposed embodiment of present invention, the solid dielectric electrolyte comprises two interfaces with two similar or dissimilar conductors which physically share the same axis.

Yet in another proposed embodiment of present invention, the solid electrolyte dielectric comprises a ferroelectric electrolyte, comprising two interfaces with two similar or dissimilar insulators.

Yet in another proposed embodiment of present invention, the ferroelectric electrolyte comprises Na-based Na_{2.99}Ba_{0.005}ClO and the two similar or dissimilar conductors are Cu.

Yet in another proposed embodiment of present invention, the ferroelectric electrolyte comprises Na-based Na_{2.99}Ba_{0.005}ClO and the two similar or dissimilar conductors are Zn and Cu.

Yet in another proposed embodiment of present invention, the ferroelectric electrolyte comprises Na-based Na_{2.99}Ba_{0.005}ClO and the two similar or dissimilar conductors are Zn and C foam or sponge or wires or nanotubes or graphene or graphite or carbon black or any other allotrope or carbon structure, with or without impurities.

Yet in another proposed embodiment of present invention, the ferroelectric electrolyte comprises Li-based (1-x) Li_{2.99}Ba_{0.005}ClO+xLi_{3-2y-z}M_{y}H_{z}ClO, with 0≤x≤1, the inner conductor comprises Li rod and the outer conductor comprises a mixture of MnO₂ with carbon black and a binder deposited on a current collector outer shell.

Yet in another proposed embodiment of present invention, the ferroelectric electrolyte comprises Na-based (1-x)Na_{2.99}Ba_{0.005}ClO+xNa_{3-2y-z}M_{y}H_{z}ClO, with 0≤x≤1 and 0≤z≤2, the inner conductor (100) comprises Na and the outer conductor comprises a mixture of Na₃V₂(PO₄)₃ with carbon black and a binder deposited on a current collector outer shell.

Yet in another proposed embodiment of present invention, the coaxial cell comprises two interfaces with two similar or dissimilar semiconductors or a conductor and a semiconductor.

Yet in another proposed embodiment of present invention, the ferroelectric electrolyte comprises Li-based Li_{2.99}Ba_{0.005}ClO+Li₂S, the conductor comprises Al and the semiconductor comprises Si.

Yet in another proposed embodiment of present invention, the ferroelectric electrolyte comprises Li-based, Li_{2.99}Ba_{0.005}ClO or a Li_{2.99}Ba_{0.005}ClO+Li_{3-2y-z}M_{y}H_{z}ClO mixture or a composite, and the conductor comprises Li or a Li alloy such as the solid solution of Mg in lithium or Li on magnesium, and an electrolyte surface area is in contact with an insulator such as air, vacuum, polymer, plasticizer, ionic liquid, insulating tape, glue, or binder.

Yet in another proposed embodiment of present invention, the coaxial cell comprises at least one interface between a ferroelectric and a superconductor.

Yet in another proposed embodiment of present invention, the superconductor comprises ZnO.

Yet in another proposed embodiment of present invention, an electrical current of electrons is conducted from the inner conductor to the outer conductor through the surface of solid dielectric electrolyte providing self-charge as in a feedback-cell at a constant temperature.

Yet in another proposed embodiment of present invention, the self-charge is ensured or enhanced under a gradient temperature from −30 to 250° C.

Yet in another proposed embodiment of present invention, the self-charge is ensured or enhanced under a variable temperature fluctuation over time from −30 to 250° C.

Yet in another proposed embodiment of present invention, the coaxial cell comprises coaxial layers associated in series or external circuit conductor wires.

Yet in another proposed embodiment of present invention, the coaxial cell comprises a structural carbon composite insulation layer.

Yet in another proposed embodiment of present invention, the coaxial cell comprises L, I, W, U, C, T, circular, squared or rectangular cross-sections structured shape arrangements.

Yet in another proposed embodiment of present invention, the coaxial cell comprises a structural arrangement as a load-carrying beam or a structural element.

The present invention also describes the use of a coaxial cell according to the above description as a part of a transistor, a computer, a photovoltaic cell or panel, a wind turbine, a vehicle, a ship, a satellite, a drone, a high-altitude pseudo-satellite, an airplane, a bridge, a remote access circuit, a building, a smart grid, electric power transmission, transformers, power storage devices, or electric motors.

Yet in another proposed embodiment of present invention, the coaxial cell is used as an energy harvester.

Yet in another proposed embodiment of present invention, the coaxial cell is used as an energy harvester and energy storage device.

Yet in another proposed embodiment of present invention, the coaxial cell is used as a signal transmission enabler.

### General Description

The present invention describes a coaxial energy storage cell using a dielectric that is also an electrolyte.

The present invention describes a coaxial energy storage cell using a dielectric that is also an electrolyte and a ferroelectric.

The present invention describes a coaxial energy harvest cell using a dielectric that is also an electrolyte and a ferroelectric.

The present invention describes a coaxial energy storage and harvest cell that is a ferroelectric-induced superconductor that can perform from below to above room temperature.

The present invention describes a coaxial feedback cell in which the potential difference may increase during discharge of the cell with a load.

The present invention describes a coaxial feedback cell in which the capacity may be obtained just by the relaxation of the cell.

The present invention describes a coaxial energy storage cell which is a coaxial cable.

The present invention describes a coaxial cell in which the thermoelectric phenomena may potentiate the output power.

The present invention describes a coaxial feedback cell in which the pyroelectric phenomena may potentiate the output power.

The present invention describes a coaxial feedback cell that may harvest kinetic energy at a constant temperature.

The present invention describes a coaxial feedback cell that may harvest heat and thermal energy.

The present invention describes a feedback cell that may store electrostatic and electrochemical energy.

The present invention describes a coaxial feedback cell in which electrons may feedback into the circuit in one electrode and conducted through the surface of the ferroelectric electrolyte, tunnelling back to the other electrode increasing the chemical potential difference and the voltage of the cell where the voltage is expected to decrease spontaneously.

The present invention describes a coaxial cell that may perform as a structural, load-bearing component that may store energy.

The present invention describes a coaxial cell that may perform as a structural, load-bearing component that may harvest energy.

It is a coaxial capacitor and an electrochemical device as the mobile ions from the electrolyte can plate, insert, or react with the cylindrical electrodes that may correspond to the current collectors and function as structural parts in buildings, roads, land and sea vehicles, airplanes, satellites, high-altitude pseudo-satellites, drones, geothermal, eolic, and photovoltaic infrastructures, computers, databanks, and others. The device is an energy storage device constituted by a cylindrical-like internal element, which constitutes one electrode and current collector, surrounded by a dielectric material that is also an electrolyte and may, or may not, be a ferroelectric material. The external shell holds, or is the second electrode, and current collector. The outer cylinder is electrically insulated and may be reinforced by materials that enhance the device's structural properties. The harvesting function may arise from the step decrease of the internal resistance and/or impedance and step increase of the dielectric constant with an increasing temperature. The device may also work as thermoelectric cell upon application of a temperature gradient, and as a pyroelectric cell upon application of a temperature variation with time. If the electrolyte is a ferroelectric material with topological superconductivity, the coaxial capacitor may also be a feedback cell with self-charging capabilities at constant temperature. The device is prone to be associated in series and in parallel. Other coaxial devices such as spheres, cubes, parallelepipeds, and others are also part of this invention.

### BRIEF DESCRIPTION OF THE DRAWINGS

For better understanding of the present application, figures representing preferred embodiments are herein attached which, however, are not intended to limit the technique disclosed herein. These and other features, aspects, and advantages of the present invention will become better understood with reference to the following description and appended claims and accompanying drawings wherein.

FIG. 1 is the embodiment of a coaxial energy-storing and/or harvesting cell constituted by an outer shell and an inner rod or shell that are two conductors with equal (made different upon charging) or different chemical potentials separated by a dielectric material that is also an electrolyte where ions can move spontaneously in order to equilibrate the chemical potentials of the materials in contact.

FIG. 2 is the embodiment of a coaxial energy-storing and/or harvesting cell constituted by an outer shell and an inner rod or shell that are two electrical conductors with equal (made different upon charging) or different chemical potentials separated by a dielectric material that is also an electrolyte. The outer and inner conducting shells may have their surfaces in contact with the electrolyte, covered by another material that reacts or can be inserted by the mobile ions resulting in an electrochemical contribution to the stored electrical energy.

FIG. 3 is the embodiment of a cylindrical coaxial energy-storing and/or harvesting cell constituted by an outer shell or mesh and an inner rod, conductive rope or shell which are two electrical conductors with equal (made different upon charging) or different chemical potentials separated by a dielectric material that is also an electrolyte. In the embodiment of FIG. 3, if the cell is set to discharge for example with a load resistor, the negative electrode is the inner conductor and the positive electrode the outer shell. An embodiment of this cell is an inner conductor such as aluminium an outer shell such as copper or carbon or both.

FIG. 4 is the embodiment of a cylindrical coaxial energy-storing and/or harvesting cell constituted by an outer shell or mesh and an inner rod, conductive-rope or shell which are two electrical conductors with equal (made different upon charging) or different chemical potentials separated by a dielectric material that is also an electrolyte. In the embodiment of FIG. 4, if the cell is discharging, the positive electrode is the inner conductor and the negative electrode the outer shell. An embodiment of this cell is an inner conductor such as copper or carbon fibres or a mesh of each or both an outer shell or mesh such as zinc or aluminium or an Al—Zn alloy or Al—Mg or other compound or alloy with higher chemical potential than carbon or copper.

FIG. 5 is the embodiment of a cylindrical coaxial energy-storing and/or harvesting cell in FIG. 3, which is connected in series with a resistor, for example a lamp. The current of electrons is conducted from the negative electrode throughout the external circuit (conductor) to the lamp and back to the positive electrode of the coaxial cell.

FIG. 6 is the embodiment of a cylindrical coaxial harvesting feedback-cell in which the electrons circulating through the external circuit are feedback in the cell by being superconducted through the surface of the electrolyte, possibly ferroelectric, from the positive to the negative electrode leading to a self-charge of the cell as the difference in chemical potentials as described in [0002], increases. In this embodiment, the inner conductor is the positive electrode and the outer shell the negative electrode.

FIG. 7 is the embodiment of a cylindrical coaxial harvesting feedback-cell in which the electrons circulating through the external circuit are feedback in the cell by being superconducted through the surface of the electrolyte, possibly ferroelectric, from the positive to the negative electrode leading to a self-charge of the cell as the difference in chemical potentials as described in [0002], increases. In this embodiment, the inner conductor is the negative electrode and the outer shell the positive electrode.

FIG. 8 is the embodiment of a cylindrical coaxial storage and harvesting feedback-cell constituted by an outer fiberglass polymer insulating shell whose inner surface is covered by a thin layer of copper in contact with the Na_{2.99}Ba_{0.005}ClO electrolyte+polymer composite which is in contact with an inner thin rod of aluminium. The cell is closed on both ends by a thermoplastic.

FIG. 9 is the embodiment of two cylindrical coaxial storage and harvesting feedback-cells in which one is constituted by an outer fiberglass polymer insulating shell whose inner surface is covered by a thin layer of copper in contact with the Na_{2.99}Ba_{0.005}ClO electrolyte+polymer composite which is in contact with an inner thin rod of aluminium such as the cell in embodiment [0047]. The two cells are in series and light a green LED.

FIG. 10 is the embodiment of a conductor1/ferroelectric-“metal” composite/conductor2 coaxial storage and harvest feedback-cell after being set to discharge in series with a resistor of 1.8 kD. The voltage versus time plot shows that the voltage instead of decreasing, as expected in traditional electrochemical or electrostatic cells, increases corresponding to self-charge. Additionally, the cell also self-cycles (pulsating voltage) for a minimum of 195 h, corresponding to a (0.1<ΔV<0.16) V, with a period of approximately two hours.

FIG. 11 is the embodiment of several beam geometries that may be used as structural energy harvesting and storage devices. For beams with circular cross section the conductor1/ferroelectric-metal composite/conductor2 coaxial storage and harvest feedback-cell can be inserted into a hollow cylinder manufactured using polymer composite materials so that the beam composed of several materials can act as a structural, load-bearing system where the different materials respond to the applied loads in a synergetic way. The same principle applies to beams with different cross-sections.

FIG. 12 is the embodiment of an application of the structural energy harvesting and storage devices in reinforced concrete structures. The structural coaxial storage and harvest feedback-cell may be used in conjunction with standard steel beams so that a facade or any other civil construction structure becomes an energy harvesting and storage component.

FIG. 13 is the embodiment of an application of the structural energy harvesting and storage devices in truss structures used for example in satellites. The structural coaxial storage and harvest feedback-cell is an element with the circular cross-section shown in the truss.

FIG. 14 is the embodiment of an application of the structural energy harvesting and storage device in a satellite solar panel (solar array). The electrical power generated by the solar panels charge the batteries that are the frames that support the photovoltaic cells.

### DESCRIPTION OF EMBODIMENTS

With reference to the figures, some embodiments are now described in more detail, which are however not intended to limit the scope of the present application.

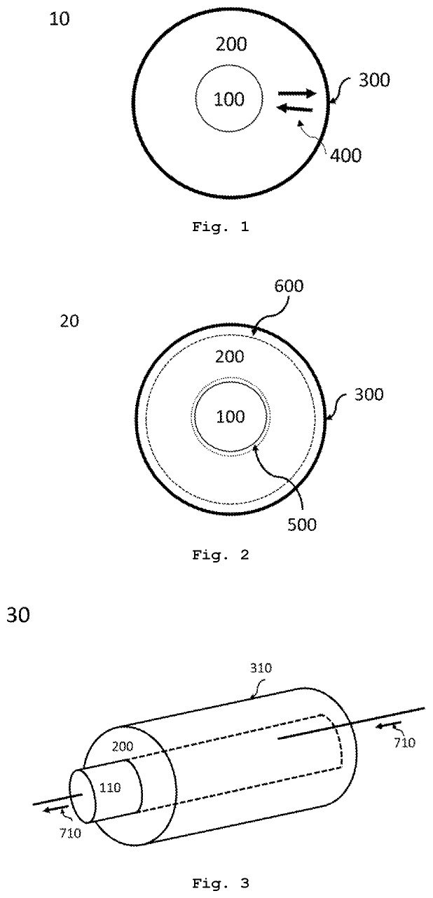

The preferred embodiments of the present invention are illustrated by way of example below and in FIGS. 1-14.

As shown in FIG. 1 the coaxial cell in an embodiment (10) where the numeric reference (100) is a conductor such as Al or Zn, the numeric reference (200) is a ferroelectric electrolyte such as the ferroelectric-electrolyte composite comprised by 80% of Na_{2.99}Ba_{0.005}ClO and 20% of a polymer that does not reduce the dielectric properties of the ferroelectric and decreases its hygroscopic properties. In the embodiment (10), the numeric reference (300) is a conductor such as Carbon or Copper, or a mixture or a fabric of both. The mobile ions (400) that the ferroelectric electrolyte (200) comprises, Na⁺ in this embodiment, diffuse from the outer conductor (300) to the inner conductor (100) when the cell is charging, and from the inner conductor (100) to the outer conductor (300) through the ferroelectric electrolyte (200) when the cell discharges.

The embodiment (20) in FIG. 2 is an electrochemical and electrostatic coaxial cell. By adding the numeric reference (500) around the the inner conductor (100), an embodiment comprising an anode active material, such as graphite, or by charging (20) prior to discharge, and, therefore, plating the alkali metal as an anode (500). In this condition, (500) is the metal corresponding to the alkali cation that is mobile in the ferroelectric electrolyte (200). On the cathode side, the numeric reference (600) is a cathode active material such as LiFePO₄, LiMn_{1.5}Ni_{0.5}O₄ or MnO₂. In embodiment (20), the cathode (600) may be lithiated and the capacity of the cathode will add to the capacity of the electrolyte in the coaxial cell.

In another embodiment (20), the numeric reference (500) can be a cathode active material and the numeric reference (600) the anode active material.

In an embodiment (30) in FIG. 3, numeric reference (110) is the negative electrode (anode upon discharge) and numeric reference (310) is the positive electrode (cathode upon discharge), and the numeric reference (710) represents the direction of the electron current during discharge. When the direction of the electron current embodied by (710) changes and represents charge, numeric reference (310) becomes an embodiment of a negative electrode and numeric reference (110) becomes the embodiment of a positive electrode. The preferred embodiment of numeric reference (710) is a conductor wire that connects to (110) and (310).

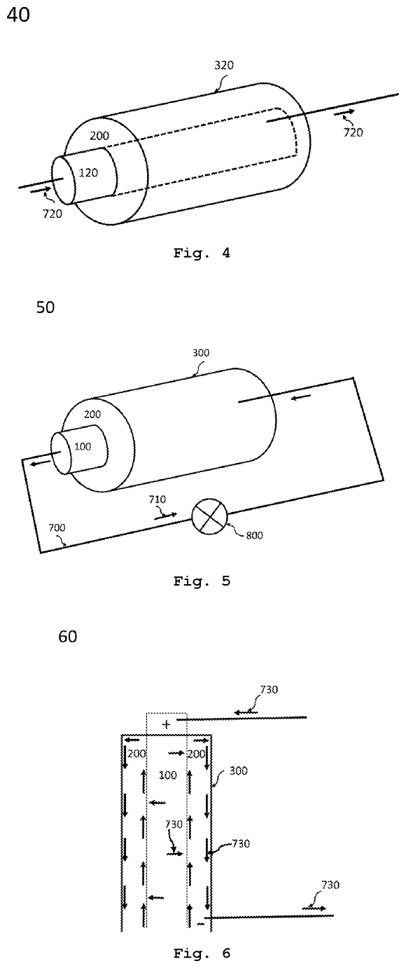

In an embodiment (40) in FIG. 4, numeric reference (120) is the negative electrode and numeric reference (320) is the positive electrode, and numeric reference (720) represents the direction of the electron current during charge. When the electron current embodied by (720) changes and represents discharge, numeric reference (320) becomes an embodiment of a negative electrode and numeric reference (120) becomes the embodiment of a positive electrode. The preferred embodiment of numeric reference (720) is a conductor wire that connects to (120) and (320).

The preferred embodiment (50) in FIG. 5 is a coaxial cell such as the embodiment of FIG. 3, where the external circuit lights a lamp or an LED (800). Embodiment (30) of FIG. 3 is, therefore, the source of electrical energy in embodiment (50).

The preferred embodiment (60) in FIG. 6 is a feedback coaxial-cell where numeric reference (100) is the positive electrode and the shell (300) is the negative electrode. The current of electrons (730) may be rapidly conducted from the positive electrode (100) to the negative electrode (300) through the surface of the ferroelectric electrolyte (200), which is a solid electrolyte, configuring self-charge in a feedback-cell. A preferred embodiment of ferroelectric electrolyte (200) is a composite comprised by 80% of Li_{2.99}Ba_{0.005}ClO and 20% of a polymer. The ferroelectric electrolyte (200) forms Electrical Double Layer Capacitors to align the chemical potentials with the electrodes (100, 300), thus storing electrical energy. A preferred embodiment for the positive electrode (100) is Cu wire and for the shell (300) is Al foil.

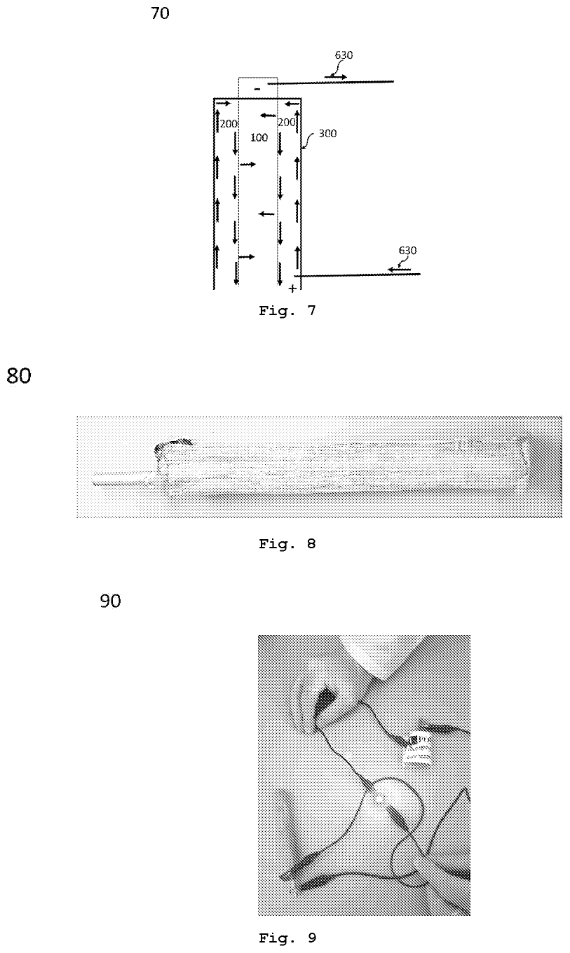

The preferred embodiment (70) in FIG. 7 is a feedback coaxial-cell where numeric reference (100) is the negative electrode and the shell (300) is the positive electrode. The current of electrons (630) may be rapidly conducted from the positive electrode (300) to the negative electrode (100) through the surface of the ferroelectric electrolyte (200), which is a solid electrolyte, configuring self-charge in a feedback-cell. A preferred embodiment of the ferroelectric electrolyte (200) is a composite comprised by 80% of Na_{2.99}Ba_{0.005}ClO and 20% of a polymer. The ferroelectric electrolyte (200) forms Electrical Double Layer Capacitors to align the chemical potentials with the electrodes (100, 300), thus storing electrical energy. A preferred embodiment for the negative electrode (100) is Zn rod and for the shell (300) is Cu mesh.

A preferred embodiment of the theoretical voltage of the cell in embodiment (70) in FIG. 7 at open circuit, without previous charge and without accounting for the voltage due to the polarization of the ferroelectric-electrolyte, is:

$$ϵ = \frac{{μ}_{Z n} - {μ}_{C u}}{e} = 0.76 + 0.32 = 1.08 V$$

A preferred embodiment for the coaxial cell (10) in FIG. 1, and (70) in FIG. 7 is the cylindrical-cell, embodiment (80), in FIG. 8. In embodiment (80), the negative electrode is a thin rod of Aluminium, which possesses a natural oxidized layer that brings the chemical potential down and is difficult to avoid. In embodiment (80), the positive electrode is a Copper tape or foil. The outer protective shell of embodiment (80) is a fibre glass polymer composite.

Two preferred embodiments for coaxial-cells shown in FIG. 9 were associated in series and connected to an LED, embodiment (90). Two cells must be associated in series to overcome the minimum voltage to light a green LED, which is 1.83 V. The coaxial-cells are the sources of energy in the circuit that is embodiment (90). The preferred coaxial-cells embodiments in (90) have the following electrodes:
the left cell
   Al—negative electrode, inner rod, and
   Cu foil—positive electrode outer shell; and
the right cell
   Cu fibres—positive electrode, and
   Al foil—negative electrode outer shell.
      Both cells have an insulating structural element to protect the cell and to enable the structural function.

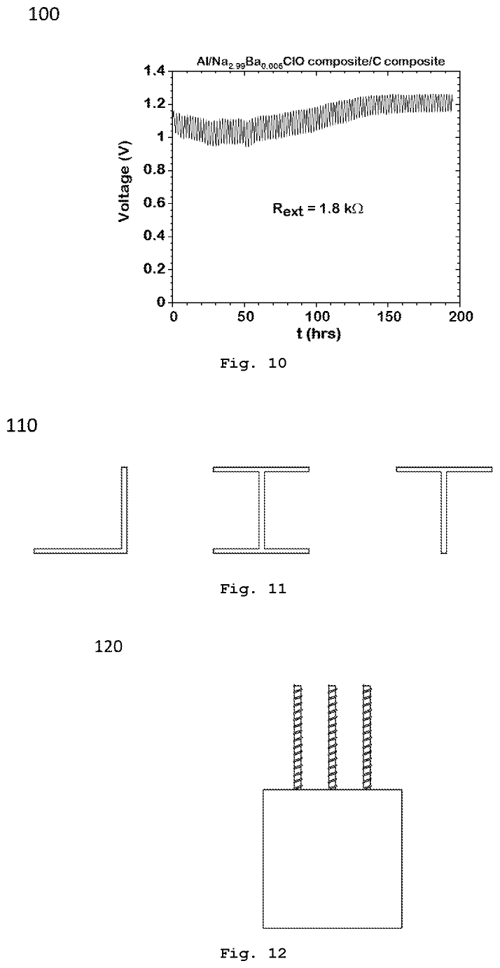

In the graph of FIG. 10, a coaxial-cell embodiment (100) comprised by an Al negative electrode inner rod, a ferroelectric-electrolyte Na_{2.99}Ba_{0.005}ClO composite, and C-fibres as positive electrode. The fibres are covered by an outer structural shell element, which is a carbon composite and that is in contact with the ferroelectric-electrolyte. The coaxial-cell is connected to a resistance of 1800 ohm and the output voltage immediately starts to oscillate, in a self-cycle, with an amplitude voltage of approximately 0.13 V and a period of approximately 1.9 hrs. In the first 30 hrs, the maximum voltage decreases from 1.16 to 1.09 V and the minimum voltage from 1.03 to 0.95 V. After a period in which the average voltage is approximately constant, the average voltage starts to increase to assume the minimum voltage of 1.16 V and the maximum voltage of 1.26 V. This latter effect is self-charge, a phenomenon that is typical of the embodiment of a feedback-cell. The cell is self-charging for 144 h (6 days).

The pyroelectric effect offers another interesting solid-state approach for harvesting ambient thermal energy to power distributed networks of sensors and actuators that are remotely located or otherwise difficult to access. There have been, however, few device-level demonstrations due to challenges in converting spatial temperature gradients into temperature oscillations necessary for pyroelectric energy harvesting.

The decoupling of phonon and electron transport is essential in Thermoelectric cells; For example, in relaxor ferroelectrics, nano-polar regions associated with intrinsic localized phonon modes provide glass-like phonon characteristics due to the large levels of phonon scattering which is highly welcome for achieving the binomial feature ‘electron-crystal phonon-glass’ for an “ideal” Thermoelectrics.

An important inference is that the “best” Thermoelectric requires high electronic carrier concentrations, ˜10¹⁸ to ˜10²¹ cm⁻³, i.e. 10²⁰ cm⁻³, associated with high electrical conductivity. These are similar conditions to those necessary for a feedback cell to work at constant temperature. Therefore, enabling the superimposition of both the feedback and TE phenomena in embodiments 1 to 140 in FIGS. 1 to 14.

The preferred embodiment (110) of FIG. 11 are coaxial-cells comprising the L, I, and T shapes that are structural beams that resist bending moments, torsional moments, shear loads and normal loads.

The preferred embodiment (120) of FIG. 12 are coaxial-cells comprising structural beams for the reinforcement of concrete with applications in the construction of buildings, walls, and bridges.

The preferred embodiment (130) of FIG. 13 are coaxial-cells comprising structural beams in truss-like structures, with applications in trains, bikes, bicycles, cars, buses, manned and unmanned aircraft, manned and unmanned helicopters, satellites, and high-altitude pseudo satellites.

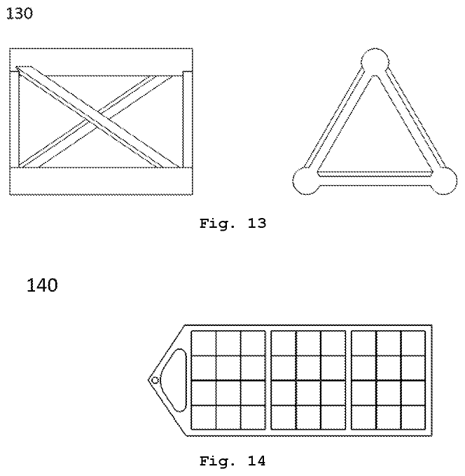

The preferred embodiment (140) of FIG. 14 are coaxial-cells comprising structural elements with applications in photovoltaic panels used in satellite solar arrays, buildings, and electric land or air vehicles.

1. A coaxial cell comprising:
a solid electrolyte dielectric (200) arranged between two similar or dissimilar nearly coaxial or coaxial materials comprising an inner conductor (100) and an outer conductor (300).

2. The coaxial cell according to claim 1, wherein
the solid dielectric electrolyte (200) comprises a range of materials composed by R_{3-2y}M_{y}Cl₁₋ₓHalₓO_{1-z}A_{z} with (R═Li, Na, K; M═Be, Ca, Mg, Sr, and Ba; Hal═F, Br, I; A═S, Se) and 0≤y≤0.5, 0≤x≤1, and 0≤z≤1, R_{3-3y}M_{y}Cl₁₋ₓHalₓO_{1-z}A_{z} with (R═Li, Na, K; M═B, Al; Hal═F, Br, I; A═S, Se) and 0≤y≤0.5, 0≤x≤1, and 0≤z≤1, R_{3-2y-z}M′_{y}H_{z}Cl₁₋ₓHalₓO_{1-d}A_{d} (R═Li, Na, K; M′═Be, Ca, Mg, Sr, and Ba; Hal═F, Br, I; A═S, Se) and 0≤y≤0.5, 0≤z≤2, 0≤x≤1, and 0≤d≤1, R_{3-3y-z}M′_{y}H_{z}Cl₁₋ₓHalₓO_{1-d}A_{d} with 0≤y≤0.5, 0≤z≤2, 0≤x≤1, and 0≤d≤1, a mixture thereof or a mixture of thereof with Li₂S, Na₂S, K₂S, Li₂O, Na₂O, K₂O, SiO₂, Al₂O₃, ZnO, AlN, LiTaO₃, BaTiO₃, HfM₂, or H₂S or a mixture thereof with a polymer, a plasticizer, or a glue.

3. The coaxial cell according to claim 1, wherein the solid electrolyte dielectric (200) comprises two interfaces with two similar or dissimilar conductors (500, 600) which physically share the same axis.

4. The coaxial cell according to claim 1, wherein the solid electrolyte dielectric (200) comprises a ferroelectric electrolyte, comprising two interfaces with two similar or dissimilar insulators.

5. The coaxial cell according to claim 4, wherein the ferroelectric electrolyte comprises Na-based Na_{2.99}Ba_{0.005}ClO and the two similar or dissimilar (500, 600) conductors are Cu.

6. The coaxial cell according to claim 4, wherein the ferroelectric electrolyte comprises Na-based Na_{2.99}Ba_{0.005}ClO and the two similar or dissimilar (500, 600) conductors are Zn and Cu.

7. The coaxial cell according to claim 4, wherein the ferroelectric electrolyte comprises Na-based Na_{2.99}Ba_{0.005}ClO and the two similar or dissimilar (500, 600) conductors are Zn and C foam or sponge or wires or nanotubes or graphene or graphite or carbon black or any other allotrope or carbon structure, with or without impurities.

8. The coaxial cell according to claim 4, wherein the ferroelectric electrolyte comprises Li-based (1-x)Li_{2.99}Ba_{0.005}ClO+xLi_{3-2y-z}M_{y}H_{z}ClO, with 0≤x≤1, the inner conductor (100) comprises Li rod and the outer conductor (300) comprises a mixture of MnO₂ with carbon black and a binder deposited on a current collector outer shell.

9. The coaxial cell according to claim 4, wherein the ferroelectric electrolyte comprises Na-based (1-x)Na_{2.99}Ba_{0.005}ClO+xNa_{3-2y-z}M_{y}H_{z}ClO, with 0≤x≤1 and 0≤z≤2, the inner conductor (100) comprises Na and the outer conductor (300) comprises a mixture of Na₃V₂(PO₄)₃ with carbon black and a binder deposited on a current collector outer shell.

10. The coaxial cell according to claim 1, comprising two interfaces with two similar or dissimilar semiconductors or a conductor and a semiconductor.

11. The coaxial cell according to claim 4, wherein the ferroelectric electrolyte comprises Li-based Li_{2.99}Ba_{0.005}ClO+Li₂S, the conductor comprises Al and the semiconductor comprises Si.

12. The coaxial cell according to claim 4, wherein the ferroelectric electrolyte comprises Li-based, Li_{2.99}Ba_{0.005}ClO or a Li_{2.99}Ba_{0.005}ClO+Li_{3-2y-z}M_{y}H_{z}ClO mixture or a composite, and the conductor comprises Li or a Li alloy such as the solid solution of Mg in lithium or Li on magnesium, and an electrolyte surface area is in contact with an insulator such as air, vacuum, polymer, plasticizer, ionic liquid, insulating tape, glue, or binder.

13. The coaxial cell according to claim 1, comprising at least one interface between a ferroelectric and a superconductor.

14. The coaxial cell according to claim 13, wherein the superconductor comprises ZnO.

15. The coaxial cell according to claim 1, wherein an electrical current of electrons (730) is conducted from the inner conductor (100) to the outer conductor (300) through the surface of solid dielectric electrolyte (200) providing self-charge as in a feedback-cell at a constant temperature.

16. The coaxial cell according to claim 1, wherein the self-charge is ensured or enhanced under a gradient temperature from −30 to 250° C.

17. The coaxial cell according to claim 1, wherein the self-charge is ensured or enhanced under a variable temperature fluctuation over time from −30 to 250° C.

18. The coaxial cell according to claim 1, comprising coaxial layers associated in series or external circuit conductor wires.

19. The coaxial cell according to claim 1, comprising a structural carbon composite insulation layer.

20. The coaxial cell according to claim 1, comprising L, I, W, U, C, T, circular, squared or rectangular cross-sections structured shape arrangements.

21. The coaxial cell according to claim 1, comprising a structural arrangement as a load-carrying beam or a structural element.

22-25. (canceled)
